(19) United States
(12) Patent Application Publication
(10) Pub. No.: US 2006/0277689 A1
(43) Pub. Date: Dec. 14, 2006

(54) Fabric treatment article and methods for using in a dryer

(76) Inventors: Stephan M. Hubig, Maplewood, MN (US); Jennifer Bergerson, Mounds View, MN (US); Nicole Burns, Elko, MN (US); Steven E. Lentsch, St. Paul, MN (US)

Correspondence Address: MERCHANT & GOULD PC, P.O. BOX 2903, MINNEAPOLIS, MN, 55402-0903, US

(21) Appl. No.: 11/455,908

(22) Filed: Jun. 19, 2006

Related U.S. Application Data
(63) Continuation-in-part of application No. 10/656,854, filed on Sep. 4, 2003, now Pat. No. 7,087,572.
Application No. 10/656,854 is a continuation-in-part of application No. 10/120,891, filed on Apr. 10, 2002.

(51) Int. Cl. C11D 3/00

(52) U.S. Cl. 8/115.51

(57) ABSTRACT

A fabric treatment article is provided. The fabric treatment article includes a fabric treatment composition and a substrate in contact with the fabric treatment composition. The fabric treatment composition includes a fabric treatment component, a carrier component, and an elasticity, shrinkage, or surface hardness additive. A method for treating fabric in a dryer is provided.

### CROSS REFERENCE TO RELATED APPLICATION

This is a continuation-in-part of U.S. application Ser. No. 10/656,854 that was filed with the United States Patent and Trademark Office on Sep. 4, 2003. U.S. application Ser. No. 10/656,854 is a continuation-in-part of U.S. application Ser. No. 10/120,891 that was filed with the United States Patent and Trademark Office on Apr. 10, 2002. The entire disclosures of U.S. application Ser. No.10/656,854 and U.S. application Ser. No. 10/120,891 are incorporated herein by reference.

### FIELD OF THE INVENTION

The invention relates to a fabric treatment article and to a method for treating fabric in a dryer using a fabric treatment article. In particular, the invention provides for the dispensing of a fabric treatment agent to fabric in a dryer during multiple drying cycles. The fabric treatment agent can be applied to impart desired beneficial properties to the fabric. The fabric treatment agent can transfer from the fabric treatment composition to wet fabric in a dryer.

### BACKGROUND OF THE INVENTION

Several types of dryer fabric softeners have been available. One type of dryer fabric softener is available as a dryer sheet. The dryer sheet is placed in the dryer along with wet laundry. The sheet is often a nonwoven sheet containing a solid composition that includes a fabric softener and a fragrance. During the drying cycle, the temperature increases as the laundry dries, causing the fabric softener to melt and transfer from the nonwoven sheet to the laundry. Dryer sheets are generally provided for a single use. If the dryer sheet becomes entangled with an article of laundry, excessive deposition onto that piece of laundry may result in “spotting.” Spotting is the condition where concentrated fabric softener causes a dark spot on a laundry item. For certain dryer sheet products, it is believed that dispensing of the fabric softener is primarily caused by the heat of the dryer melting the fabric softener on the dryer sheet. It is believed that this mostly takes place near the end of the drying cycle when the temperature within the dryer increases.

Dryer sheets containing fabric softeners are described by U.S. Pat. No. 3,442,692 to Gaiser; U.S. Pat. No. 3,686,025 to Morton; U.S. Pat. No. 4,834,895 to Cook et al.; U.S. Pat. No. 5,041,230 to Borcher, Sr. et al.; and U.S. Pat. No. 5,145,595 to Morris et al.

Another type of dryer fabric softener is available as a pouch containing a fabric softener composition. The pouch can be attached to the dryer drum. During the drying cycle, the increase in temperature can melt a portion of the composition inside the pouch. The melted composition then passes through the pouch and transfers to the laundry. The pouch type dryer fabric softener can be available for multiple uses. An exemplary type dryer fabric softener was available under the name “Free 'N Soft” from Economics Laboratory of St. Paul, Minn. Examples of pouch type dryer fabric softeners are disclosed by U.S. Pat. No. 3,870,145 to Mizuno; U.S. Pat. No. 3,967,008 to Mizuno et al.; and U.S. Pat. No. 4,098,937 to Mizuno et al.

Additional fabric softener compositions are disclosed by U.S. Pat. No. 3,972,131 to Rudy et al. and U.S. Pat. No. 4,035,307 to Fry et al.

### SUMMARY

A fabric treatment article is provided according to the invention. The fabric treatment article includes a fabric treatment composition and a substrate in contact with the fabric treatment composition. The fabric treatment composition is provided in the form of a mass having a size of at least about 25 grams, and comprises a result of melt mixing about 30 wt. % to about 70 wt. % of a fabric softener component comprising at least one quaternary ammonium compound, about 10 wt. % to about 60 wt. % carrier component, and about 5 wt. % to about 30 wt. % elasticity, shrinkage, or surface hardness additive. The fabric treatment composition, when provided having a size of 6 inch×1 inch×⅛ inch, has a flexibility of at least about 0.2 inch and strength sufficient to withstand a maximum load of at least about 1 lb_{f} when tested on a 5544 Instron material test instrument using 4 inch posts separated by 4 inches, a shrinkage of less than 5% after placing in an oven for two weeks at 107° C., and a surface hardness sufficient to reduce penetration of a 3 mm diameter ball to less than 3 mm depth in the composition when provided at a temperature of 140° F. and at a force of 150 grams.

A method for treating fabric in a dryer is provided according to the invention. The method includes the step of drying fabric in a dryer in the presence of a fabric treatment article attached to an inside surface of the dryer. The fabric treatment article includes the fabric treatment composition and the substrate in contact with the fabric treatment composition. The substrate can be received within a cradle that is attached to the inside surface of a dryer.

### BRIEF DESCRIPTION OF THE DRAWINGS

FIG. 1 is a perspective view of a fabric treatment article according to the priciples of the present invention.

FIG. 2 is a perspective view of a substrate of the fabric treatment article of FIG. 1.

FIG. 3 is a perspective view of a cradle for holding the fabric treatment article of FIG. 1.

### DETAILED DESCRIPTION OF THE INVENTION

Fabric treatment articles for use in a dryer are provided by the invention. A fabric treatment article according to the invention can be referred to more simply as a “treatment article” or as an “article.” The fabric treatment article includes a fabric treatment composition and a substrate attached to the fabric treatment composition. The fabric treatment composition can be provided in a form or shape that allows for delivery of a fabric treatment agent in the fabric composition to fabric during multiple cycles in a dryer. The fabric treatment composition can be referred to more simply as the “composition.” The substrate is provided for attaching the article to the inside surface of a dryer. The substrate can attach to a cradle that attaches to the inside surface of a dryer.

The fabric treatment article can be attached to the inside of a dryer and can be used during multiple cycles of the dryer to impart a fabric treatment agent to fabric during a drying operation in a dryer. In order to remain available for multiple drying cycles in a dryer, the composition can be provided so that it resists melting during operation of the dryer in which it is placed. Resistance to melting can be exhibited by a lack of flow of the composition during a drying cycle. Flow of the composition can be characterized by a puddling of the composition onto fabric or at the bottom of the dryer. By resisting melting, the composition remains in its form attached to the substrate that is attached to the inside surface of the dryer.

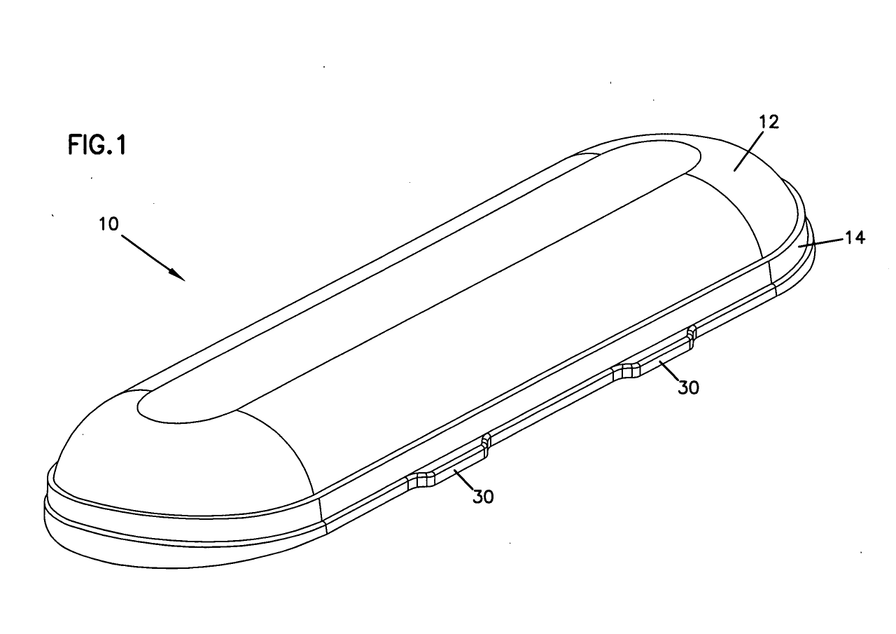

Now referring to FIG. 1, a fabric treatment article is shown at reference number 10. The fabric treatment article includes a fabric treatment composition 12 and a substrate 14. The fabric treatment composition 12 can be characterized as a block form and is provided attached to the substrate 14. The fabric treatment article 10 can be attached to a cradle attached to the interior surface of a dryer, and the fabric treatment article 10 can be removed from the cradle and replaced with another fabric treatment article. Fabric treatment articles can be replaced when they are worn out or they can be swapped out when it is desirable to introduce a fabric treatment article that contains an alternative fabric treatment agent. Accordingly, once a fabric treatment article has been exhausted or worn out, it can be replaced with a new fabric treatment article. Furthermore, multiple fabric treatment articles can be made available where each fabric treatment article contains a different fabric treatment agent, and the user can select the fabric treatment article to impart the desired fabric treatment agent to the laundry during a drying operation.

The fabric treatment composition 12 and the substrate 14 can be attached together as a result of melt mixing the components of the fabric treatment composition and molding the fabric treatment composition 12 onto the substrate 14.

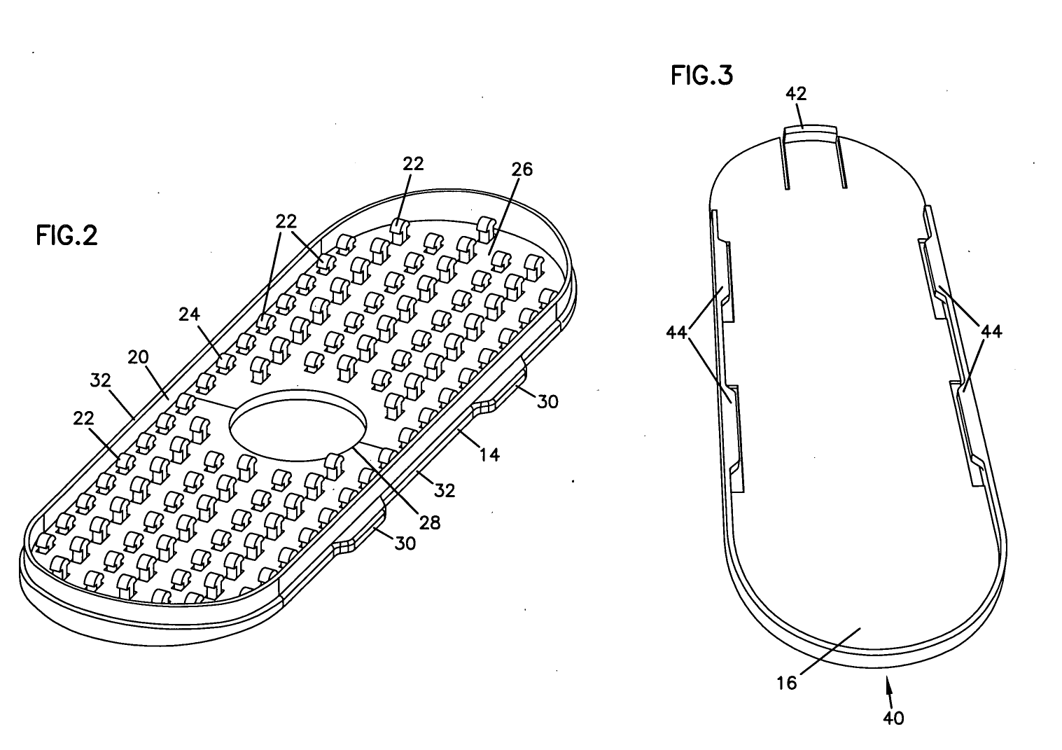

Now referring to FIG. 2, the substrate 14 is shown separate from the fabric treatment composition 12. The substrate 14 includes a lip 20 that extends around the periphery of the substrate 14, and a plurality of projections 22 that engage the fabric treatment composition and help hold the fabric treatment composition to the substrate 14. The plurality of projections 22 can include a hook 24 that helps hold onto the fabric treatment composition. The fabric treatment composition and the substrate 14 can be attached together by allowing the fabric treatment composition to solidify and thereby engaging the plurality of projections 22. For example, the substrate 14 can be placed over a mold so that the surface 26 forms a top side of the mold cavity. A melted fabric treatment composition can be introduced into the cavity through the opening 28, and the cavity can be sufficiently filled so that the fabric treatment composition engages the top surface 26 and the plurality of projections 22. Cooling the fabric treatment composition allows it to solidify and the resulting fabric treatment article can be removed from the mold.

The substrate 14 can include ears 30. The ears 30 can project from the substrate sides 32. The cradle can engage the ears 30 to help hold the fabric treatment article in place in the cradle.

Now referring to FIG. 3, a cradle is shown at reference number 16. The cradle 16 includes a back surface 40 that attaches to the interior surface of a dryer. The cradle 16 can include a catch 42 that can be depressed to allow the fabric treatment article to slide in and out of the cradle 16. In addition, the cradle 16 can include a plurality of lips 44 that engage the ears 30 on the substrate 14. Accordingly, one can introduce a fabric treatment article into the cradle 16 by depressing the catch 42 and sliding the fabric treatment article in place so that the ears 30 engage the lips 44. Once the fabric treatment article is in place in the cradle 16, the catch 42 holds the fabric treatment article in place until the catch 42 is depressed and the fabric treatment article is allowed to slide out from the cradle 16.

The fabric treatment article is constructed to dispense fabric treatment agent to fabric during multiple cycles in a dryer. In order to enhance the longevity of the fabric treatment article, it is desirable to reduce separation of the fabric treatment composition from the substrate. Separation can have a tendency of reducing the useful life of the fabric treatment article. Separation can have a tendency to occur when the fabric treatment composition exhibits cracking, crumbling, warping, or bowing.

The fabric treatment article can be subjected to wide temperature swings, and can be subjected to a wide temperature swing on a daily basis or even more frequently. Because dryers are often vented to the outdoors, it is common for dryers, when not in use, to reach a temperature that approximates the outdoor temperature. Furthermore, during operation, dryers can achieve a relatively high temperature. Residential dryers often achieve a temperature of about 160° F., and industrial dryers often achieve a temperature of about 240° F. Relatively large temperature swings can contribute to internal stresses within the fabric treatment article. A relatively large temperature swing can be characterized by a temperature swing of at least about 100° F. In addition, a relatively large temperature swing can be characterized by a temperature swing of at least about 150° F., or at least 200° F. A temperature swing of about 150° F. can be expected in a residential dryer when the outdoor temperature is below 0° F., and a temperature swing of at least about 200° F. can be seen in an industrial dryer when the outdoor temperature is below about 0° F. Furthermore, the internal stresses may become problematic when the degree of temperature related expansion of the fabric treatment composition and the degree of temperature related expansion of the substrate are different. Accordingly, if the fabric treatment composition and the substrate expand at different rates as a result of a change in temperature, internal stresses may become so great that cracking, crumbling, warping or bowing of the fabric treatment composition occurs or a separation of the fabric treatment composition from the substrate occurs.

The substrate of the fabric treatment article can be provided to hold the fabric treatment composition to the inside surface of an automatic dryer. The inside surface of a dryer refers to the surface within the wheel of a dryer that contains and contacts materials such as fabrics that are dried in the dryer. The substrate can attach directly to the inside surface of the dryer, or the substrate can attach to a cradle that attaches to the inside surface of the dryer. Several exemplary substrate and cradle configurations that can be used with the fabric treatment composition are disclosed, for example, in U.S. Pat. No. 6,910,614 to Griese et al., U.S. Pat. No. 6,910,640 to Griese et al., U.S. Pat. No. 6,779,740 to Lentsch et al., U.S. Pat. No. 6,883,723 to Griese et al., U.S. Pat. No. 6,899,281 to Griese et al., U.S. Pat. No. 6,908,041 to Griese et al., U.S. Patent Publication No. US 2003/0192197 to Griese et al., U.S. Pat. Publication No. US 2004/0089731 to Griese et al., U.S. Patent Publication No. US 2004/0159717 to Griese et al., U.S. Patent Publication No. US 2004/0159718 to Griese et al., and U.S. Patent Publication No. US 2004/0222313 to Lentsch et al. These patents and published applications are incorporated herein by reference.

By subjecting the fabric treatment article to several drying cycles and relatively large temperature swings, the fabric treatment composition and the substrate can be selected to provide a desired level of compatibility between the fabric treatment composition and the substrate during the use of the fabric treatment article. In general, compatibility refers to the lack of separation of the fabric treatment composition from the substrate, or the lack of cracking, crumbling, warping or bowing of the fabric treatment composition. Because the fabric treatment composition and the substrate contain different materials, there is a tendency for the fabric treatment composition and the substrate to expand and contract at different rates as a result of temperature changes. By controlling the composition of the fabric treatment composition and the composition of the substrate, it is possible to provide enhanced compatibility.

The substrate can be formed from a polymer composition. Exemplary polymer compositions that can be used to form the substrate include polyethylene, polypropylene, polycarbonate, polyamide, polyester, and mixtures thereof. Glass fiber filled polyamide such as glass fiber filled nylon 66 can be used to provide a substrate having desired thermal expansion and contraction properties.

In order to withstand relatively large temperature swings, the fabric treatment composition can be constructed to provide a desired level of elasticity, shrinkage, and surface hardness. By selecting the components of the fabric treatment composition to provide the desired levels of elasticity, shrinkage, and surface hardness, it is possible to decrease the internal stresses within the fabric treatment composition and thereby reduce the occurrence of cracking, crumbling, warping, or bowing and thereby reduce the tendency for the fabric treatment composition to separate from the substrate.

The elasticity of the fabric treatment composition can be characterized by properties of flexibility and strength. For a composition having a specific size, flex distance testing is a measure of flex distance prior to break. For purposes of this test, the composition has a size of 6 inch×1 inch×⅛ inch. The composition size of 6 inch×1 inch×⅛ inch can be referred to as the “sample bar.” The test can be carried out on a 5544 Instron material test instrument. For a fabric treatment composition having a size of 6 inch×1 inch×⅛ inch (sample bar) and subjected to flex distance testing prior to break on a 5544 Instron material test instrument having a separation of 4 inches between 4-inch posts (on center), the sample bar is placed on the posts to provide 1 inch overhang on each side of each part and a plunger is applied to the center of the sample bar. As part of the test, the instrument is set up to bend the sample bar at a rate of 0.1 inch per minute. A desired flexibility can be characterized by a sample bar exhibiting a flexibility of at least about 0.2 inch. Preferred ranges of flexibility are about 0.2 inch to about 5 inches, about 0.3 inch to about 4 inches and about 0.5 inch to about 3 inches.

Elasticity can additionally be characterized by strength. Strength refers to the force at which a given sample breaks. In general, the fabric treatment composition is expected to be impacted when various articles being dried hit it inside of a dryer. Accordingly, it is desirable for the fabric treatment composition to withstand these impacts. For a fabric treatment composition provided as a sample bar and tested on a 5544 Instron material test instrument configured as described for the flex distance test, the composition can withstand a maximum load of at least about 1 lb_{f} before breaking Preferably, the composition can withstand a maximum load of at least about 1.5 lb_{f} before breaking and at least about 2.0 lb_{f} before breaking.

Shrinkage refers to the decrease in the longest dimension of the fabric treatment composition after testing at a given temperature for a given length of time. Shrinkage is considered a problem because it causes stress between the block and the substrate. The property of shrinkage can be reported based upon the decrease in the longest dimension of the fabric treatment composition after the fabric treatment composition has been placed in an oven for two weeks at 107° C. Shrinkage can be determined by the following formula:

$$Shrinkage = \frac{length before test - length after test}{Length before test} \times 100$$

Although an ideal shrinkage is 0% shrinkage, it is expected that the composition may exhibit shrinkage of, for example, at least about 0.05%. In general, the composition can be provided having a shrinkage of less than about 5%, less than about 3%, less than about 2%, or less than about 1%.

The fabric treatment composition can be provided having a surface hardness that reduces the ability of the fabric or other articles being dried to pull off the composition too easily during the drying cycle as a result of shear or to rub forces during drying. If the surface treatment composition does not have a desired level of surface hardness, it is expected that there may be too much dispensing of the fabric treatment composition during a drying cycle. The surface hardness can be determined by a penetration test where the composition has a surface temperature of 220° F. and an internal temperature of about 170° F., and a 3 mm diameter ball is applied against the surface of the composition at a force of 150 grams for 5 seconds. Under this test, the fabric treatment composition has a desired surface hardness when the 3 mm diameter ball does not penetrate more than 26 mm. Accordingly, a desired level of penetration can be 0 to about 26 mm. In general, it is expected that the penetration will be at least about 1 mm.

The fabric treatment composition can be provided having a sufficiently high melting point so that the fabric treatment composition does not flow as a mass during drying in a dryer. It is desirable for the fabric treatment composition to remain in its form during a drying operation. Because of the relatively high operating temperatures of residential and commercial dryers, it can be desirable for the fabric treatment composition to exhibit a melting point of greater than about 90° C. Furthermore, the fabric treatment composition can exhibit a melting temperature of greater than about 95° C., greater than about 100° C., greater than about 110° C., or greater than about 120° C. The melting temperature can be determined by placing a small amount of the composition between two glass slides that are placed on a fischer melting point apparatus wherein wetting out of the composition occurs at the melting point.

The fabric treatment composition includes a fabric treatment agent and a carrier for containing or holding the fabric treatment agent. The fabric treatment composition can additionally contain an additive that improves the properties of elasticity, shrinkage, surface hardness, or combinations thereof for the fabric treatment composition. The additive for improving properties of elasticity, shrinkage, surface hardness, or combinations thereof can be referred to as the elasticity, shrinkage, or surface hardness additive (ESS additive).

The fabric treatment agent is the chemical component or components of the composition that imparts the desired beneficial properties to the fabric. The carrier is provided for containing and holding the fabric treatment agent in a desired shape and for facilitating transfer of the fabric treatment agent to the fabric during the drying operation. The carrier can be characterized as a dispensing carrier or a non-dispensing carrier depending upon whether the carrier transfers to the fabric. In the case of a dispensing carrier, both the carrier and the fabric treatment agent transfer to the fabric. In the case of a non-dispensing carrier, the fabric treatment agent transfers to the fabric without transfer of the carrier. A dispensing carrier can exhibit a wide range of dispensing properties. That is, a large amount or a very little amount of the dispensing carrier can transfer to the fabric. In the context of the description of the invention, it should be understood that, unless specifically indicated, the transfer of the fabric treatment agent can include or not include transfer of the carrier. In addition, it should be understood that other components that may be present in the fabric treatment composition can be transferred along with the fabric treatment agent. In addition, multiple fabric treatment agents can transfer when they are present in the fabric treatment composition.

The fabric treatment agent or the fabric treatment composition transfers to wet fabric during a drying operation as a result of contact between the wet fabric and the fabric treatment composition. It is believed that transfer can occur as a result of solubilizing the fabric treatment agent or the fabric treatment composition. The solubilized fabric treatment agent or fabric treatment composition transfers to the wet fabric as a result of contacting the wet fabric. As the fabric dries, it is expected that the rate of transfer decreases. It is believed that the primary mechanism for transfer of the fabric treatment agent or the fabric treatment composition is solubility as a result of the presence of water in the fabric during a drying operation. The temperature within the dryer may assist in solubilizing the fabric treatment agent or the fabric treatment composition. In addition, it is expected that in certain circumstances some amount of the fabric treatment agent or the fabric treatment composition may rub off onto the fabric and it is possible that a certain amount of the fabric treatment agent or the fabric treatment composition may transfer to the fabric by a mechanism other than by solubilizing onto the wet fabric. Nevertheless, it is expected that the water in the fabric will facilitate and will be primarily responsible for transferring the fabric treatment agent and/or the fabric treatment composition to the fabric. The Applicants base this theory on their observation that running dry towels in a dryer in the presence of an exemplary fabric treatment composition resulted in negligible transfer of the fabric treatment composition to the dry towels.

It is desirable for the fabric treatment composition to resist melting during operating conditions in the dyer so that melt transfer of the fabric treatment composition to the fabric will be relatively small, if it exists at all, and will likely not be a primary mechanism for transfer to the fabric. Once the fabric inside the dryer is considered dry, and there is no remaining free water on the fabric to solubilize the fabric treatment agent or the fabric treatment composition, and it is expected that there will be substantially no transfer of the fabric treatment agent or the fabric treatment composition to the fabric by a solubility mechanism. It is possible that there may be some transfer as a result of a rubbing or friction between the fabric and the fabric treatment composition depending upon the components selected for the fabric treatment composition and the operating temperature in the dryer. However, it is expected that a fabric treatment amount of the fabric treatment agent transfers as a result of contact with the wet fabric.

Fabric that can be processed according to the invention include any textile or fabric material that can be processed in a dryer for the removal of water. Fabrics are often referred to as laundry in the case of industrial and domestic (or residential) laundry operations. While the invention is characterized in the context of treating “fabric,” it should be understood that items or articles that include fabric can similarly be treated. In addition, it should be understood that items such as towels, sheets, and clothing are often referred to as laundry and are types of fabrics. Additional laundry items that can be treated by the fabric treatment composition include athletic shoes, accessories, stuffed animals, brushes, mats, hats, gloves, outerwear, tarpaulins, tents, and curtains.

The dryers in which the fabric softener composition according to the invention can be used include any type of dryer that uses heat and agitation or air flow to remove water from the laundry. An exemplary dryer includes a tumble-type dryer where the laundry is provided within a rotating drum that causes the laundry to tumble during the operation of the dryer. Tumble-type dryers are commonly found in residences and in commercial and industrial laundry operations.

The fabric treatment composition is provided for releasing an effective amount of the fabric treatment agent to the laundry during a drying cycle in a dryer to provide the desired beneficial property or properties to the fabric or item or article being treated. It is believed that the effective amount of the fabric treatment agent is transferred primarily as a result of solubility by contacting the wet laundry and the fabric treatment composition in the dryer, and that as the fabric becomes dryer and there is less free water in the fabric, the rate of transfer as a result of solubilizing the fabric treatment agent decreases. It is expected that the transfer can be essentially stopped once the fabric becomes sufficiently dry. The exact mechanism of the transfer is not precisely known, but it is believed that the transfer is likely the result of the wet laundry solubilizing a portion of the fabric treatment composition or a rubbing off of a portion of the fabric treatment composition onto the wet laundry as the wet laundry contacts the fabric treatment composition during the tumbling operation in a dryer. As the laundry dries, it is expected that less of the fabric treatment agent will transfer to the laundry. It should be understood that there may be relatively small or amounts of transfer after the fabric dries, but it is expected that this amount of transfer, if it occurs at all is insufficient to impart the desired beneficial properties to the fabric. Because of this decrease of transfer, the fabric treatment composition can be characterized as a “smart composition.” By dispensing by moisture control, it is possible to avoid overdosing that may result if the composition were to transfer by melting. This is in contrast to the expected operation of certain commercial dryer sheets that are believed to be temperature activated. In the case of certain temperature activated dryer sheets, it is expected that a softening agent is released when the laundry is relatively dry and the temperature within the dryer achieves a certain temperature. In addition, the transfer continues until the softening agent is completely released from the dryer sheet or until the drying operation is interrupted.

While the inventors believe that the fabric treatment agent transfers to fabric as a result of solubility in water, it should be understood that this is the Applicants' theory and other mechanisms may explain the transfer.

The Fabric Treatment Composition

The fabric treatment composition includes a fabric treatment agent, a carrier component, and an additive for improving elasticity, shrinkage, or surface hardness. The fabric treatment agent is generally responsible for providing or imparting the various beneficial properties to the fabric. The carrier component mixes with the fabric treatment agent and helps the fabric treatment agent resist transfer to fabric or laundry by melting during the drying operation. The carrier component can be chosen so that the fabric treatment composition exhibits a melting point or softening point that is above the operating temperature of the dryer. It is expected that industrial or commercial dryers operate at incoming air temperatures that are typically provided in the range of between about 190° F. and about 240° F., and home or residential dryers often operate at incoming air temperatures of between about 120° F. and about 160° F. It should be understood that the temperature of the home or residential dryer can often be changed depending upon the item being dried. It is sometimes desirable to run the home dryer at room temperature (about 50° F. to about 60° F.) in situations where, for example, fluff is desired. As a result, the fabric treatment composition can be provided having a melting temperature or softening temperature that is relatively low but that exceeds the intended operating temperature of the dryer. In the case of a fabric treatment composition intended to be used in a commercial dryer, the melting temperature and softening temperature can be provided in excess of 240° F. In the case of a fabric treatment composition intended to be used in a home or residential dryer, the fabric treatment composition can be provided having a melting temperature or softening temperature in excess of 160° F. It should be understood that if the fabric treatment composition is intended to be used in a home or residential dryer that is intended to be operated on a fluff cycle, the melting temperature or softening temperature can be provided in excess of 70° F. In many applications, it is expected that the melting temperature of the fabric treatment composition will be above about 90° C. The melting temperature of the fabric treatment composition can be above about 95° C., above about 100° C., above about 110° C., or above about 120° C. In addition, the melting temperature of the fabric softener composition can be below about 200° C. The melting temperature of the fabric treatment composition refers to the temperature at which the composition begins to flow under its own weight. As the fabric treatment composition reaches its melting point, one will observe the composition undergoing a transfer from a solid discrete mass to a flowable liquid. Although a differential scanning calorimeter (DSC) measurement of the composition may reveal that certain portions or phases of the composition may exhibit melting at temperatures that are within the operating temperatures of a dryer, it should be understood that what is meant by the melting temperature of the composition is not the melting temperature of certain portions or phases within the composition, but the melting temperature of the composition as demonstrated by the composition being visibly observed as a flowable liquid. It is expected that the fabric treatment composition may be provided as a solid mixture including multiple phases or as a solid solution including a single phase. The softening temperature of the composition refers to the temperature at which the solid mass becomes easily deformable. For many exemplary compositions according to the invention, it is expected that the softening temperature will be a few degrees below the melting temperature.

Fabric Treatment Agent

The fabric treatment agent can include any component that provides desired beneficial properties to fabric or laundry as a result of its presence when used during drying of wet laundry in a tumble dryer. The fabric treatment agent can be applied to fabric in a dryer to impart various beneficial properties to the fabric. Exemplary beneficial properties include softening, anti-static, anti-wrinkling, dye transfer inhibition/color protection, odor removal/odor capturing, soil shielding/soil releasing, ultraviolet light protection, fragrance, sanitizing, disinfecting, water repellency, mosquito repellency, anti-pilling, souring, mildew removing, allergicide properties, skin care, and combinations thereof.

The fabric treatment agent can include a fabric softener agent or component when it is desired to impart fabric softening properties to the fabric. Exemplary components that can be used as the fabric softener agent includes those fabric softeners that are commonly used in the laundry drying industry to provide fabric softening properties.

A general type of fabric softener component that can be used according to the invention can be referred to as quaternary ammonium compounds. Exemplary quaternary ammonium compounds include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof.

Exemplary alkylated quaternary ammonium compounds include ammonium compounds having an alkyl group containing between 6 and 24 carbon atoms. Exemplary alkylated quaternary ammonium compounds include monoalkyl trimethyl quaternary ammonium compounds, monomethyl trialkyl quaternary ammonium compounds, and dialkyl dimethyl quaternary ammonium compounds. Examples of the alkylated quaternary ammonium compounds are available commercially under the names Adogen™, Arosurf®, Variquat®, and Varisoft®. The alkyl group can be a C₈-C₂₂ group or a C₈-C₁₈ group or a C₁₂-C₂₂ group that is aliphatic and saturated or unsaturated or straight or branched, an alkyl group, a benzyl group, an alkyl ether propyl group, hydrogenated-tallow group, coco group, stearyl group, palmityl group, and soya group. Exemplary ring or cyclic quaternary ammonium compounds include imidazolinium quaternary ammonium compounds and are available under the name Varisoft®. Exemplary imidazolinium quaternary ammonium compounds include methyl-1hydr. tallow amido ethyl-2-hydr. tallow imidazolinium-methyl sulfate, methyl-1-tallow amido ethyl-2-tallow imidazolinium-methyl sulfate, methyl-1-oleyl amido ethyl-2-oleyl imidazolinium-methyl sulfate, and 1-ethylene bis (2-tallow, 1-methyl, imidazolinium-methyl sulfate). Exemplary aromatic quaternary ammonium compounds include those compounds that have at least one benzene ring in the structure. Exemplary aromatic quaternary ammonium compounds include dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds. The alkyl group can contain between about 6 and about 24 carbon atoms, and can contain between about 10 and about 18 carbon atoms, and can be a stearyl group or a hydrogenated tallow group. Exemplary aromatic quaternary ammonium compounds are available under the names Variquat® and Varisoft®. The aromatic quaternary ammonium compounds can include multiple benzyl groups. Diquaternary ammonium compounds include those compounds that have at least two quaternary ammonium groups. An exemplary diquaternary ammonium compound is N-tallow pentamethyl propane diammonium dichloride and is available under the name Adogen 477. Exemplary alkoxylated quaternary ammonium compounds include methyldialkoxy alkyl quaternary ammonium compounds, trialkoxy alkyl quaternary ammonium compounds, trialkoxy methyl quaternary ammonium compounds, dimethyl alkoxy alkyl quaternary ammonium compounds, and trimethyl alkoxy quaternary ammonium compounds. The alkyl group can contain between about 6 and about 24 carbon atoms and the alkoxy groups can contain between about 1 and about 50 alkoxy groups units wherein each alkoxy unit contains between about 2 and about 3 carbon atoms. Exemplary alkoxylated quaternary ammonium compounds are available under the names Variquat®, Varstat®, and Variquat®. Exemplary amidoamine quaternary ammonium compounds include diamidoamine quaternary ammonium compounds. Exemplary diamidoamine quaternary ammonium compounds are available under the name Varisoft®. Exemplary amidoamine quaternary ammonium compounds that can be used according to the invention are methyl-bis(tallow amidoethyl)-2-hydroxyethyl ammonium methyl sulfate, methyl bis (oleylamidoethyl)-2-hydroxyethyl ammonium methyl sulfate, and methyl bis (hydr.tallowamidoethyl)-2-hydroxyethyl ammonium methyl sulfate. Exemplary ester quaternary compounds are available under the name Stepantex™.

The quaternary ammonium compounds can include any counter ion that allows the component to be used in a manner that imparts fabric-softening properties according to the invention. Exemplary counter ions include chloride, methyl sulfate, ethyl sulfate, and sulfate.

Quaternary ammonium compounds that can be used as fabric softener components can be available as relatively pure or concentrated quaternary ammonium compounds or they can be provided in a medium. Exemplary mediums include solvents and/or surfactants. When the quaternary ammonium compounds are provided in a medium, they can be provided in the medium in an amount of between at least about 50 wt. %, or between about 50 wt. % and about 99 wt. %, or between about 70 wt. % and about 95 wt. %, or between about 75 wt. % and about 90 wt. %. Exemplary mediums for the quaternary ammonium compounds include alcohols, glycols, nonionics, fatty alcohols, fatty acids, triglycerides, and solid esters. An exemplary alcohol that can be used is isopropanol. Exemplary glycols that can be used include hexylene glycol and propylene glycol. Exemplary nonionics include ethoxylated alcohols. Exemplary fatty alcohols include stearyl alcohols. Exemplary fatty acids include hard tallow acids and stearic acid. Exemplary triglycerides include hydrogenated tallow. Exemplary solid esters include stearyl stearate.

Certain fabric softener agents can be incorporated into the fabric treatment composition that exhibit reduced yellowing. The reduction in yellowing can be observed in either or both of the solid fabric treatment composition and the fabrics that are treated. It is expected that consumers will prefer a fabric treatment composition that retains its original color (such as white) and resists yellowing after several uses. In addition, it is desirable to provide a fabric softening agent that does not cause significant yellowing of fabrics that are repeatedly washed and dried.

When the fabric treatment composition includes a softening agent for providing softening properties, it is generally desirable for the fabric that is dried to remain white even after multiple drying cycles. That is, it is desirable that the fabric treatment composition not generate too much yellowing after repeated cycles of drying in the presence of the fabric treatment composition. Whiteness retention can be measured according to a whiteness index using, for example, a Hunter Lab instrument. In general, it is desirable for the fabric treated, such as 12 terry cloth towels, to exhibit a whiteness retention of at least 90% after 10 drying cycles. The whiteness retention can be greater than 95% after 10 drying cycles.

It is generally desirable for fabric treated in a dryer using the fabric treatment composition to possess a softness preference that is at least comparable to the softness preference exhibited by commercially available dryer sheets such as Bounce® and Downy® from Proctor & Gamble. The softness preference is derived from a panel test with one-on-one comparisons of fabric (such as towels) treated with the fabric treatment composition according to the invention or with a commercially available dryer sheet. In general, it is desirable for the softness preference resulting from the fabric treatment composition to be superior to the softness preference exhibited by commercially available dryer sheets.

The fabric treatment composition can include an amount of the fabric softener agent to provide fabric softener properties. The fabric treatment composition can include the fabric softening agent in an amount of at least about 30 wt. % to impart sufficient fabric softening properties. In general, it is expected that if there is too much fabric softening agent in the fabric treatment composition, the composition may not exhibit sufficient resistance to melting during the operation of a dryer. Accordingly, it can be desirable to keep the fabric softening agent present at a level below about 80 wt. %. Exemplary ranges of the fabric softening agent in the fabric treatment composition include about 30 wt. % to about 70 wt. %, about 40 wt. % to about 60 wt. %, and about 45 wt. % to about 55 wt. %.

The fabric treatment composition, when it includes an anti-static agent, can generate a percent static reduction of at least about 50% when compared with fabric that is not subjected to treatment. The percent static reduction can be greater than 70% and it can be greater than 80%. The test for static reduction can be carried out on 12 cotton terry towels and/or 12 50/50 poly/cotton pillowcases. It has been observed that fabric treated using the fabric treatment composition according to the invention exhibit more constant percent static reduction compared with commercially available dryer sheets.

The fabric treatment agent can include anti-static agents such as those commonly used in the laundry drying industry to provide anti-static properties. Exemplary anti-static agents include those quaternary compounds mentioned in the context of softening agents. Accordingly, a benefit of using softening agents containing quaternary groups is that they may additionally provide anti-static properties.

The fabric treatment agent can include an anti-wrinkling agent to provide anti-wrinkling properties. Anti-wrinkling agents can include siloxane or silicone containing compounds. In addition, anti-wrinkling agents can include: quaternary ammonium compounds. Exemplary anti-wrinkling agents include polydimethylsiloxane diquaternary ammonium that is available under the name Tegopren 6922 from Degussa-Goldschmidt; a cationic silicone that is available under the name Lube SCI-QL from Lambert Technologies; a polysiloxane that is available under the name FC201 from Walker Silicones; an aminosilicone available under the name Hydrosoft from Rhodia; and polydimethyl siloxane with polyoxyalkylenes under the name Tinotex CMA from CIBA.

The fabric treatment agent can include odor capturing agents. In general, odor capturing agents are believed to function by capturing or enclosing certain molecules that provide an odor. Exemplary odor capturing agents include cyclodextrins, and zinc ricinoleate. Exemplary order capturing agents are available under the name Tegosorb from Degussa-Goldschmidt. The fabric treatment composition can contain the order capturing agent in an amounts sufficient to provide desired order capturing properties. An exemplary range of the order capturing agent is about 1 wt. % to about 5 wt. %.

The fabric treatment agent can include fiber protection agents that coat the fibers of fabrics to reduce or prevent disintegration and/or degradation of the fibers. Exemplary fiber protection agents include cellulosic polymers. The fabric treatment composition can contain the fiber protection agent in an amount sufficient to provide desired fiber protection properties. An exemplary range of fiber protection agent in the fabric treatment composition is about 1 wt. % to about 5 wt. %.

The fabric treatment agent can include color protection agents for coating the fibers of the fabric to reduce the tendency of dyes to escape the fabric into water. Exemplary color protection agents include quaternary ammonium compounds and surfactants. An exemplary quaternary ammonium color protection agent includes di-(nortallow carboxyethyl) hydroxyethyl methyl ammonium methylsulfate that is available under the name Varisoft WE 21 CP from Degussa-Goldschmidt. An exemplary surfactant color protection agent is available under the name Varisoft CCS-1 from Degussa-Goldschmidt. An exemplary cationic polymer color protection agent is available under the name Tinofix CL from CIBA. Additional color protection agents are available under the names Color Care Additive DFC 9, Thiotan TR, Nylofixan P-Liquid, Polymer VRN, Cartaretin F-4, and Cartaretin F-23 from Clariant; EXP 3973 Polymer from Alco; and Coltide from Croda. The fabric treatment composition can contain the color protection agent in an amount sufficient to provide desired color protection properties. An exemplary range of color protection agent in the fabric treatment composition is about 5 wt. % to about 20 wt. %.

The fabric treatment agent can include soil releasing agents that can be provided for coating the fibers of fabrics to reduce the tendency of soils to attach to the fibers. Exemplary soil releasing agents include polymers such as those available under the names Repel-O-Tex SRP6 and Repel-O-Tex PF594 from Rhodia; TexaCare 100 and TexaCare 240 from Clariant; and Sokalan HP22 from BASF. The fabric treatment composition can contain the releasing agents in an amount sufficient to provide desired soiling releasing properties. An exemplary range of releasing agents in the fabric treatment composition is about 1 wt. % to about 10 wt. %.

The fabric treatment agent can include optical brightening agents that impart fluorescing compounds to the fabric. In general, fluorescing compounds have a tendency to provide a bluish tint that can be perceived as imparting a brighter color to fabric. Exemplary optical brighteners include stilbene derivatives, biphenyl derivatives, and coumarin derivatives. An exemplary biphenyl derivative is distyryl biphenyl disulfonic acid sodium salt. An exemplary stilbene derivative includes cyanuric chloride/diaminostilbene disulfonic acid sodium salt. An exemplary coumarin derivative includes diethylamino coumarin. Exemplary optical brighteners are available under the names Tinopal 5 BM-GX, Tinopal CBS-CL, Tinopal CBS-X, and Tinopal AMS-GX from CIBA. The fabric treatment composition can contain the optical brightening agents in an amount sufficient to provide desired optical brightening properties. An exemplary range of optical brightening agents in the fabric treatment composition is about 0.5 wt. % to about 2 wt. %.

The fabric treatment agent can include a UV protection agent to provide the fabric with enhanced UV protection. In the case of clothing, it is believed that by applying UV protection agents to the clothing, it is possible to reduce the harmful effects of ultraviolet radiation on skin provided underneath the clothing. As clothing becomes lighter in weight, UV light has a greater tendency to penetrate the clothing and the skin underneath the clothing may become sunburned. An exemplary UV protection agent includes Tinosorb FD from CIBA. The fabric treatment composition can contain the UV protection agent in an amount sufficient to provide desired UV protection properties. An exemplary range of UV protection agent in the fabric treatment composition is about 0.5 wt. % to about 2 wt. %.

The fabric treatment agent can include an anti-pilling agent that acts on portions of the fiber that stick out or away from the fiber. Anti-pilling agents can be available as enzymes such as cellulase enzymes. Exemplary cellulase enzyme anti-pilling agents are available under the names Puradex from Genencor and Endolase and Carezyme from Novozyme. The fabric treatment composition can contain the anti-pilling agent in an amount sufficient to provide desired anti-pilling properties. An exemplary range of anti-pilling agent in the fabric treatment composition is about 0.5 wt. % to about 2 wt. %.

The fabric treatment agent can include water repellency agents that can be applied to fabric to enhance water repellent properties. Exemplary water repellents include perfluoroacrylate copolymers, hydrocarbon waxes, and polysiloxanes. The fabric treatment composition can contain the water repellency agents in an amount sufficient to provide desired water repellency properties. An exemplary range of water repellency agent in the fabric treatment composition is about 1 wt. % to about 10 wt. %.

The fabric treatment agent can include disinfecting and/or sanitizing agents. Exemplary sanitizing and/or disinfecting agents include quaternary ammonium compounds such as alkyl dimethylbenzyl ammonium chloride, alkyl dimethylethylbenzyl ammonium chloride, octyl decyldimethyl ammonium chloride, dioctyl dimethyl ammonium chloride, and didecyl dimethyl ammonium chloride. The fabric treatment composition can contain the disinfecting and/or sanitizing agents in an amount sufficient to provide desired disinfecting and/or sanitizing agents properties. An exemplary range of disinfecting and/or sanitizing agents in the fabric treatment composition is about 1 wt. % to about 25 wt. %.

The fabric treatment agent can include souring agents that neutralize residual alkaline that may be present on the fabric. The souring agents can be used to control the pH of the fabric. The souring agents can include acids such as saturated fatty acids, dicarboxylic acids, and tricarboxylic acids. Exemplary acids include those that remain solid under conditions of operation in the dryer. While it may be desirable to provide components in the fabric treatment composition that are solid during conditions of operation of the dryer, that is not necessary. It is expected that certain components may be liquid under conditions of operation in the dryer and the composition may still function as desired. Exemplary saturated fatty acids include those having 10 or more carbon atoms such as palmitic acid (C₁₆), stearic acid (C₁₈), and arachidic acid (C₂₀). Exemplary dicarboxylic acids include oxalic acid, tartaric acid, glutaric acid, succinic acid, adipic acid, and sulfamic acid. Exemplary tricarboxylic acids include citric acid and tricarballylic acids. The fabric treatment composition can contain the souring agent in an amount sufficient to provide desired souring properties. An exemplary range of souring agent in the fabric treatment composition is about 1 wt. % to about 25 wt. %.

The fabric treatment agent can include insect repellents such as mosquito repellents. An exemplary insect repellent is DEET. In addition, the fabric treatment agent can include mildewcides that kill mildew and allergicides that reduce the allergic potential present on certain fabrics and/or provide germ proofing properties.

The fabric treatment agent can include skin care ingredients. Exemplary skin care ingredients include moisturizers, sking antiwrinkling agents, skin UV protection agents, and vitamines (e.g., vitamin E), skin lotion, and aloe vera. When the fabric treatment composition includes a skin care ingredient, the skin care ingredient can be included in an amount of about 1 wt. % to about 5 wt. %.

Carrier Component

The carrier component of the fabric treatment composition can be any component that helps contain the fabric treatment component within the composition, allows the fabric treatment component to transfer to wet laundry, and provides the fabric treatment composition with a melting temperature or a softening temperature that is greater than the operating temperature of the dryer. The carrier component can be characterized as a dispensing carrier or a non-dispensing carrier depending upon whether the carrier component transfers to the wet laundry during a drying operation in a dryer. A non-dispensing carrier does not, in general, transfer to wet laundry although it allows other components in the composition to transfer to wet laundry. The dispensing carrier does transfer to wet laundry and the amount of transfer can vary depending upon the materials selected as the dispensing carrier.

The carrier component can be any component that mixes with the fabric treatment agent and forms a fabric treatment composition having a desired shape and that allows transfer of the fabric treatment agent to wet fabric during a drying operation in a dryer. The carrier component and the fabric treatment agent can be melted, mixed, and allowed to solidify to form a desired shape. Exemplary techniques for forming the composition include injection molding, casting, solution mixing, and melt mixing. It should be understood that mixing in an extruder is a form of melt mixing that occurs generally at relatively high pressures. In general, it may be desirable for the carrier component and the fabric treatment component to be soluble in each other, and sufficiently water soluble to allow water solubility induced movement of the composition to wet fabric during a drying operation in a dryer. The fabric treatment agent can be sufficient compatible with the carrier component that is can be characterized as a plasticizer for the carrier component. The carrier component can be selected to provide the fabric treatment composition as a solid during a drying operation in a dryer. Although a differential scanning calorimeter (DSC) measurement of the composition may reveal that certain portions or phases of the composition may exhibit melting at temperatures that are within the operating temperatures of a dryer, it should be understood that what is meant by the melting temperature of the composition is not the melting temperature of certain portions or phases within the composition, but the melting temperature of the composition as demonstrated by the composition being visibly observed as a flowable liquid. It is expected that the fabric softener composition may be provided as a solid mixture including multiple phases or as a solid solution including a single phase. The softening temperature of the composition refers to the temperature at which the solid mass becomes easily deformable. For many exemplary compositions according to the invention, it is expected that the softening temperature will be a few degrees below the melting temperature.

Exemplary carrier components that can be used according to the invention include ethylene bisamides, primary alkylamides, alkanolamides, polyamides, alcohols containing at least 12 carbon atoms, alkoxylated alcohols containing alkyl chain of at least 12 carbon atoms, carboxylic acids containing at least 12 carbon atoms, and derivatives thereof.

Exemplary ethylene bisamides include those having the following formula: 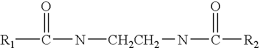
wherein R₁ and R₂ are alkyl groups containing at least 6 carbon atoms, and can be straight or branched, saturated or unsaturated, cyclic or noncyclic, and can include ethylene oxide groups and/or propylene oxide groups. R₁ and R₂ can be C₆-C₂₄ alkyl groups. R₁ and R₂ can be the same or different. Exemplary ethylene bisamides include ethylene bis-stearamide, ethylene bispalmitamide, ethylene bisoleamide, ethylene bisbehenamide, and mixtures thereof. An exemplary mixture of ethylene bisamides includes a mixture of ethylene bis-stearamide and ethylene bis-palmitamide which is available under the names Acrawax C from Lonza, Inc. or EBS PR from Crompton Corp.

Exemplary primary alkylamides include those having the following formula: 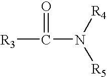
wherein R₃ is a C₆-C₂₄ alkyl group that may be straight or branched, saturated or unsaturated, cyclic or noncyclic, and R₄ and R₅ can be hydrogen or C₁-C₂₄ alkyl groups that are straight or branched, saturated or unsaturated, cyclic or noncyclic. R₄ and R₅ can be the same or different. An exemplary primary alkylamide is stearamide. An exemplary primary alkanolamide is available under the name Wax 160 from Frank B. Ross Co. (fatty acid amide mixture).

Exemplary alkanolamides include those having the following formula: 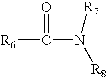
Wherein R₆ is a C₆-C₂₄ alkyl group that may be straight or branched, saturated or unsaturated, cyclic or noncyclic. R₇ and R₈ can be the same or different. When they are different, one can be hydrogen and the other can be an alkanol group such as C₂H₄OH or C₃H₆OH. When they are the same, they can each be an alkanol group such as C₂H₄OH or C₃H₆OH.

Exemplary alcohols include those having the following formula:
R₉—OH
wherein R₉ is a C₁₂ to C₂₄ alkyl group that can be straight or branched, saturated or unsaturated, cyclic or noncyclic. Exemplary alcohols include stearyl alcohol and behenyl alcohol.

Exemplary alkoxylated alcohols include those having the formula:
R₁₀—O(AO)ₓ
wherein R₁₀ is a C₁₂-C₂₄ alkyl group that is straight or branched, saturated or unsaturated, cyclic or noncyclic, and AO is an ethylene oxide or propylene oxide group, and x is a number from 1 to 100.

Exemplary polymers that can be used as the carrier component include polyalkylenes such as polyethylene, polypropylene, and random and/or block copolymers of polyethylene and polypropylene; polyethers such as polyethylene glycol; and polyesters such as biodegradable polymers such as polylactide and polyglycolic acid; polyurethanes; polyamides; polycarbonates; polysulfones; polysiloxanes; polydienes such as polybutylene, natural rubbers, and synthetic rubbers; polyacrylates such as polymethylmethacrylate; and addition polymers such as polystyrene and polyacrylonitrile-butadiene-styrene; mixtures of polymers; and copolymerized mixtures of polymers.

The fabric treatment composition includes a sufficient amount of the carrier component to provide the composition with the desired resistance to melting during the operation of a dryer. In order to provide sufficient resistance to melting, the fabric treatment composition can include at least about 10 wt. % of the carrier component. In general, it is desirable for the fabric treatment composition to contain one or more fabric treatment agents. Accordingly, it is desirable to leave enough room for the fabric treatment agent and the elasticity, shrinkage, or surface hardness additive. In general, the fabric treatment composition can include about 10 wt. % to about 60 wt. % of the carrier component, about 20 wt. % to about 55 wt. % of the carrier component, about 30 wt. % to about 50 wt. % of the carrier component, or about 35 wt. % to about 45 wt. % of the carrier component.

Elasticity, Shrinkage, or Surface Hardness Additive

The elasticity, shrinkage, or surface hardness additive can be provided to enhance the properties of strength, shrinkage, or surface hardness of the fabric treatment composition. Exemplary additive components include waxes, organic acid, surfacants, and clays. Exemplary waxes include polyethylene waxes, polar modified polyethylene waxes, oxidized polyethylene waxes, polypropylene waxes, polar modified polypropylene waxes, amide modified polypropylene waxes, polyethylene-polypropylene copolymer waxes, waxes containing alcohols, amides waxes, and hyperbranched polymer waxes. Exemplary polyethylene waxes include: Luwax AL61 (BASF), Luwax EAS series (BASF), Luwax A (BASF), Polywax polyethylene series (Baker Hughes), Licocene PE series (Clariant). Exemplary polar modified polyethylene waxes include those containing vinylacetate copolymers, examples include Licowax PE890 and Licowax 371FP (Clariant). Exemplary oxidized polyethylene waxes include Luwax OA series (BASF) and Petrolite series (Baker Hughes). Exemplary polypropylene waxes include Propyltex (Clenacorp), Licowax PP220 or 230, Licocene PP6102 (Clariant), and Ceridust 6050M (Clariant). Exemplary polar modified polypropylene waxes include Licomont AR503 or 504 (Clariant), and Cardis 314 (Baker Hughes). Exemplary amide modified polypropylene waxes include Ceridust TP6721 (Clariant). Exemplary polyethylene-polypropylene copolymer waxes include Licocene PP1302, 1502, or 1602 (Clariant). Exemplary waxes containing alcohols include ethoxylated waxes such as Unithox products (Baker Hughes) and Unilin 425 (Baker Hughes). Exemplary amide waxes include Wax160 (Frank B. Ross), Ceridust 3910 (Clariant), Licowax FA-) (Clariant), Licowax FA-E (Clariant). Exemplary hyperbranched polymer waxes include VYBAR products (Baker Hughes). Exemplary organic acids include monocarboxylic acids, dicarboxylic acids, tricarboxylic acids, and hydroxycarboxylic acids. An exemplary monocarboxylic acid includes fatty acids. Exemplary dicarboxylic acids include adipic acid, oxalic acid, succinic acid, fumaric acid, and phthalic acid. An exemplary tricarboxylic acid is hydroxy tricarboxylic acid such as citric acid. Exemplary surfactants that can be used include alkoxylated alcohols. Exemplary alkoxylated alcohols include those having the formula code:
R₁₁—O(AO)ₓ
wherein R₁₁ is a C₁₂-C₂₄ alkyl group that is straight or branched, saturated or unsaturated, cyclic or noncyclic, and AO is an ethylene oxide or propylene oxide group, and x is a number from 1 to 200. An exemplary alkoxylated alcohol includes Steareth-100 (e.g. Volpo-S-100 by Croda). Exemplary clays that can be used include Laponite RD (Southern Clay), Laponite B (Southern Clay), and Mineral Colloid MO.

The fabric treatment composition can include a sufficient amount of the ESS additive to provide the fabric treatment composition with the desired properties of elasticity, shrinkage, or surface hardness. For example, the fabric treatment composition can include about 5 wt. % to about 30 wt. % of the ESS, about 8 wt. % to about 25 wt. % of the ESS, or about 10 wt. % to about 20 wt. % of the ESS.

Additional components that can be included in the fabric softener composition include plasticizers, fragrances, and dyes.

Preparation of Composition

The fabric softener composition can be prepared by mixing the components at a temperature sufficient to allow the components to sufficiently mix. It is expected that the temperature can be sufficient to melt the carrier component. The step of mixing can take place at a temperature in excess of about 100° C. In general, the components should not be mixed at a temperature that is so high that it harms or discolors the components of the composition. For many components of the fabric softener composition, the mixing temperature can be less that about 180° C. An exemplary range for mixing is between about 120° C. and about 150° C. Once the components are sufficiently mixed, the composition is molded onto the substrate and the composition is shaped to provide a desired form.

Solid Form

The fabric treatment composition can be provided in a variety of solid forms. The fabric treatment composition can be constructed in a form that provides for “multiple uses.” It should be understood that multiple uses refers to the ability to dispense sufficient amounts of the fabric treatment agent during multiple cycles in a dryer. It should be understood that multiple cycles refers to at least 2 cycles. Preferably, multiple use compositions can be capable of dispensing a sufficient amount of the fabric treatment agent for at least about 5 cycles, at least about 10 cycles, at least about 50 cycles, or at least about 80 cycles. In addition, multiple use compositions can be provided that are capable of dispensing a sufficient amount of the fabric treatment agent up to about 200 cycles, up to about 150 cycles, or up to about 100 cycles. Exemplary ranges of cycles include about 2 to about 200, about 50 to about 150, or about 80 to about 100. In industrial applications, it can desirable to provide between about 50 cycles and about 150 cycles. In the context of residential or home use, it can be desirable to provide between about 30 cycles and about 60 cycles.

The fabric treatment article can attach to a structure within the dryer. As the wet fabric or laundry contacts an exposed surface of the fabric treatment composition, it is expected that the fabric treatment agent and/or the fabric treatment composition will solubilize and transfer to the fabric or laundry. Several exemplary substrate and cradle configurations that can be used with the fabric treatment composition are disclosed, for example, in U.S. Pat. No. 6,910,614 to Griese et al., U.S. Pat. No. 6,910,640 to Griese et al., U.S. Pat. No. 6,779,740 to Lentsch et al., U.S. Pat. No. 6,883,723 to Griese et al., U.S. Pat. No. 6,899,281 to Griese et al., U.S. Pat. No. 6,908,041 to Griese et al., U.S. Patent Publication No. US 2003/0192197 to Griese et al., U.S. Patent Publication No. US 2004/0089731 to Griese et al., U.S. Patent Publication No. US 2004/0159717 to Griese et al., U.S. Patent Publication No. US 2004/0159718 to Griese et al., and U.S. Patent Publication No. US 2004/0222313 to Lentsch. These patents and published applications are incorporated herein by reference.

Exemplary forms of the fabric treatment article include blocks or strips that can be placed within a drying machine so that a surface of the fabric softener composition is exposed to laundry during the drying operation. Exemplary forms include a rectangular block and a rectangular strip. Additional forms include half-cylindrical shapes with the exposed surfaces and edges being curved or rounded for better dispensing. The shape of the fabric treatment composition can be used to control dispensing of the fabric treatment agent. For example, it has been observed that the presence of sharp edges that contact fabric during a drying operation in a dryer may have a tendency to deliver more fabric treatment agent and/or fabric treatment composition to the fabric until the edges become worn down compared with an otherwise identical fabric treatment composition that contains curved or rounded edges. Accordingly, the shape of the fabric treatment composition can be used to deliver more of a certain fabric treatment agent to fabric during early stages. For example, when a fabric treatment composition is new, it may be desirable to include water repellent agents in the edge portions of the fabric treatment composition with the expectation that fabric treated by new fabric treatment composition will receive a higher dose of water repellent agents. Accordingly, the fabric treatment composition can include multiple fabric treatment agents provided at different locations within the fabric treatment composition as desired to control the stage at which certain fabric treatment agents become released.

The fabric treatment composition can be placed on an interior wall of a dryer so that the fabric treatment composition contacts the laundry or items inside the dryer that are being dried. The interior wall can be a fin of the dryer or it can be some other wall. For example, the interior wall can be a door, an end wall, or a glass window.

The fabric treatment composition can have a variety of sizes. The sizes may differ depending upon the fabric treatment agent provided within the composition. For example, the fabric treatment composition can be provided as a fabric softener composition having a size of at least about 25 grams. When the fabric softener composition is provided having a size of at least about 25 grams, it is expected that it will provide fabric softening and/or antistatic properties for laundry in multiple cycles of a dryer. An exemplary size is about 30 g to about 170 g. It is expected that the fabric softening composition can have different sizes depending upon whether it is intended to be used in an industrial drying operation or it is intended to be used in a consumer or residential dryer. In the case of use in an industrial dryer, it is expected that the fabric softening composition will have a size of between about 150 grams and about 400 grams. When it is expected to be used in a consumer or home dryer, it is expected that the fabric softener composition can have a size of between about 30 grams and about 100 grams. A reason for a size difference between industrial use and residential use relates to the size of industrial and residential dryers. There is generally more room inside an industrial dryer to provide a larger fabric softener composition compared with a residential dryer. In the case of an industrial application, it is expected that the composition can have between about 50 cycles and about 150 cycles before replacement. In the case of residential use, it is expected that the composition can have between about 30 cycles and about 60 cycles before replacement. Although the above discussion focused on the size and the number of cycles for the fabric softener composition, it should be understood that the discussion additionally applies to the fabric treatment composition.

The fabric treatment composition includes a sufficient amount of the fabric treatment agent so that the composition releases a desired amount of the fabric treatment agent during a drying cycle to impart the desired beneficial properties to the fabric being dried. In general, it is desirable for the composition to release a sufficient amount of the fabric treatment agent to provide the desired beneficial properties and it is desirable not to release too much that could create waste or adversely affect the fabric. It is expected that the ratio of the fabric treatment component to the carrier component will vary depending upon the fabric treatment agent and the carrier component and the desired level of transfer of either or both of the fabric treatment agent and the carrier component.

In the case of a fabric treatment composition that includes a fabric softener agent, the fabric softener agent and the carrier component can be mixed together to provide a fabric softener composition that releases a desired amount of fabric softener component during the drying cycle when placed inside of a dryer. The weight ratio of the fabric softener component to the carrier component can be greater than about 1:19 and can be greater than about 1:10. The ratio of the fabric softener component to the carrier component can be less than about 19:1, and can be less than about 10:1. An exemplary weight ratio of fabric softener component to carrier component is between about 1:19 to about 19:1. The ratio of the fabric softener component to the carrier component can be between about 1:10 and about 10:1, or can be between about 3:7 and about 9:1. It should be understood that the reference to the fabric softener component refers to the component responsible for providing fabric-softening properties, and is not meant to include the medium that may be present with the fabric softener component. That is, the fabric softener component may be commercially available in a medium that can be a solvent or a surfactant. Furthermore, the medium can be the same as or different from the carrier component. Although the above discussion focuses on the weight ratio of the fabric softener component to the carrier component, it should be understood that the same ratios can be applied to the fabric treatment component and the carrier component.

During the drying cycle, the fabric treatment composition should release a sufficient amount of the fabric treatment agent to provide a desired level of beneficial properties to the fabric. The amount of the fabric treatment agent that is released can be designed so that it depends on the fabric treatment agent and the amount of the agent needed to provide the desired beneficial properties. When it is desirable to provide UV protection and optical brightening, it is expected that about 10⁻⁶ to about 10⁻³ grams per pound of dry linen will be released. When it is desirable to provide fragrance to the fabric, it is expected that about 10⁻⁴ to about 10⁻² grams per pound of dry laundry will be released, and when it is desired to provide softening, anti-wrinkling, color protecting and soil releasing properties, it is expected that about 10⁻³ to about 1 gram per pound of dry linen will be released.

When the fabric treatment composition is used during a drying cycle, it is expected that the amount of the composition that will transfer to the fabric will depend on the fabric treatment agent and the carrier component. In the case of non-dispensing carriers, it is expected that the amount of the composition that is transferred to the wet fabric may be the same as the amount of the fabric treatment agent that is transferred to the fabric. It should be understood that additional components may be present in the fabric treatment composition that may transfer to the fabric. In the case of dispensing carriers, it is expected that the amount of the dispensing carrier that is transferred will depend upon the dispensing carrier selected. For example, it may be desirable to select a load dispensing carrier when the fabric treatment composition includes a fabric treatment agent that can be transferred in relatively small quantities. For example, in the case of a UV protectant, an optical brightener, or a fragrance, it may be desirable to select a carrier that provides low dispensing of the carrier. A higher dispensing carrier may be selected when it is desirable to transfer larger amounts of the fabric treatment agent. For example, when the fabric treatment agent that is dispensed includes fabric softeners, anti-wrinkling agents, color protectants, and soil releasants, it is expected that the higher dispensing carriers may be selected so that the fabric treatment composition transfers about 0.01 to about 1 gram per pound of dry linen for each cycle.

During the drying cycle, the fabric softener composition should release a sufficient amount of the fabric softener composition to provide a desired level of softening properties and, if desired, antistatic properties. In addition, the fabric softener composition should not release too much of the fabric softener component that would result in spotting of the laundry. It is expected that during the drying cycle, the fabric softener composition will lose between about 0.01 to about 1.0 gram of the fabric softener composition per pound of dry laundry. The amount of loss per drying cycle can be between about 0.02 to 0.75 gram of the fabric softener composition per pound of dry laundry, and can be between about 0.05 to 0.50 gram of fabric softener composition per pound of dry laundry. In the situation where a dryer that is rated for a 30 pound capacity is used to dry laundry, the dry weight of the laundry is typically about 15 pounds. In this situation, a block of fabric softener composition having a size of about 150 grams is expected to lose about 1.5 grams per drying cycle and provide softening for 100 cycles. It should be understood that the size of the dryer and the size of the fabric softener composition can vary for different types of dryers and drying conditions. For example, there are various sizes of dryers that are commonly used in industrial laundry facilities and in residential or consumer environments. Although the above characterization of exemplary doses applies to fabric softener compositions, it should be understood that it additionally applies to the fabric treatment composition. In addition, it should be understood that various fabric treatment compositions may include higher or lower dosing per cycle depending upon the selected fabric treatment agent.

The fabric treatment composition can be designed to provide the user with a signal indicating when it is time to replace the composition with a new composition. For example, a hook and loop fastener can be embedded or placed underneath the composition. Once the composition is ready for replacement, the hook and loop fastener becomes exposed and laundry items become attached to the hook and loop fastener thereby signaling to the operator that it is time to replace the composition. In addition, a shiny material such as a foil can be embedded or placed underneath the composition. Once the composition is ready for replacement, shiny pieces of material may start falling off and becoming part of the dry fabric thereby signaling to the user that it is time to change the composition. In addition, a tag can be used similar to the shiny material so that the tag falls off and becomes a part of the dried fabric. The user or a subsequent handler of the dried fabric will read the tag that signals to the user that the composition should be replaced.

Applications

Although the fabric treatment composition can be used to impart certain beneficial properties to fabrics or laundered items during the drying operation in a dryer, the fabric treatment composition can be used to impart certain benefits further downstream. For example, in housekeeping areas, delivery of an anti-static agent to a dust cloth or mop may assist in the removal of dust when the cloth or mop is used. In addition, a polishing agent can be imparted to a cloth or polishing substrate to assist with polishing an article. In the vehicle care industry, water repellents and/or static control agents may be applied to substrates in a dryer to allow those substrates to impart those materials to a vehicle surface.

The fabric treatment composition can be provided with a variety of suggested shapes to help the user understand how the fabric treatment composition can be used. For example, in a situation where the fabric treatment composition is used to impart an insect repellent to fabric, the composition can be provided in the form of a bug.

### EXAMPLE 1

Flexure Test

Flexibility and strength tests were carried out using a 5544 Instron material test instrument equipped with a three-point loading accessory. The three-point loading accessory includes two 4-inch high arms separated by four inches on center. The plunger of the material test instrument engages the sample bar at a midpoint between the arms. The sample bar has a size of 6 inch×1 inch×⅛ inch (15.2 cm×2.5 cm×0.3 cm). The sample bar is loaded on the arms so that 1 inch of the sample bar overhangs each arm. The arms have rounded contact areas that contact the sample bar. The plunger that bends the sample bar downwards is also curved at the point of contact The material test instrument is set up to bend the sample bar at a rate of 0.1 inch per minute.

The sample bars were cast using an aluminum mold with two chambers that are filled from the top. The dimension of the chambers is 15.2 cm long 2.5 cm wide by 0.3 cm deep.

The sample bar has a desired flexibility when the 5544 Instron material test instrument reports a flexibility of greater than 0.2 inches, and the sample bar has a desired strength when the 5544 Instron material test instrument reports a strength of more than 1 lb._{f}.

Table 1 reports flexibility and strength measurements for exemplary sample bar compositions.

TABLE 1
Flexibility and Strength Measurements

| | | | | | | citric | | | |
|---|---|---|---|---|---|---|---|---|---|
| | amido quat | ethylene bis- | fragrance | stearic acid | adipic acid | acid | | Change in | Max. Load |
| Sample | (wt. %) | stearamide¹ (wt. %) | (wt. %) | ethoxylate² (wt. %) | (wt. %) | (wt. %) | wax (wt. %) | Ext flexibility (in) | Strength (lb) |
| 1 | 30 | 50 | | | | | 20 wt. % polar | 0.700 | 3.300 |
| | | | | | | | modified | | |
| | | | | | | | polypropylene³ | | |
| 2 | 44 | 36 | | | | 20 | | 2.475 | 2.475 |
| 3 | 44 | 46 | | | | 10 | | 0.745 | 1.825 |
| 4 | 39 | 46 | | | 5 | 10 | | 0.695 | 2.550 |
| 5 | 44 | 46 | | 5 | 5 | | | 1.025 | 2.325 |
| 6 | 39 | 41 | | 5 | 5 | 10 | | 0.695 | 2.450 |
| 7 | 30 | 55 | | | | | 15 w. % | 0.205 | 3.800 |
| | | | | | | | Ethoxylated | | |
| | | | | | | | wax⁴ | | |
| 8 | 30 | 60 | | 5 | | 5 | | 0.510 | 2.550 |
| 9 | 44 | 54 | | | | | 2 wt. % | 0.570 | 2.670 |
| | | | | | | | fluorosilicate⁵ | | |
| 10 | 37.5 | 46 | 1.5 | | | | 10 wt. % | 0.246 | 2.920 |
| | | | | | | | oxidized | | |
| | | | | | | | polyethylene | | |
| | | | | | | | wax⁶ | | |
| | | | | | | | and 5 wt. % | | |
| | | | | | | | polyethylene | | |
| | | | | | | | wax⁷ | | |

¹Acrawax C is available from Lonza, Inc.
²Steareth-100 is available under the name Volpo-S-100 from Croda.
³Cardis 314 is available from Baker Hughes.
⁴Unithox 480 is available from Baker Hughes.
⁵Laponite B is available from Southern Clay Products.
⁶Luwax OA5 is available from BASF.
⁷Luwax EAS5 is available from BASF.

### EXAMPLE 2

Shrinkage Test

It is believed that extreme temperature cycles due to heating of the fabric treatment composition during the dryer cycle and then exposure to freezing (winter) temperatures in the night through the exterior vents may contribute to the brittleness of the fabric treatment composition. In addition, permanent shrinkage of the product upon multiple temperature cycles may cause warping of the fabric treatment composition since the plastic base is not shrinking. In order to test the effects of temperature swings on the fabric treatment composition, sample bars were placed in an oven at a temperature of 107° C. for a period of 2 weeks and then examined. The amount of shrinkage is reported relative to the original length of the bar. In general, minimum shrinkage is sought to match the temperature behavior of the plastic base on which the product is cast.

A desirable range would be less than 5%, more desirably less than 3%, and more desirably less than 2%. The test results are reported in Table 2.

TABLE 2
Skrinkage

| | amido quat | ethylene bis- | fragrance | wax | Shrinkage |
|---|---|---|---|---|---|
| Sample | (wt. %) | stearamide (wt. %) | (wt. %) | (wt. %) | (%) |
| 1 | 50 | 33.5 | 1.5 | 15 wt. % OA 5 | 1.84 |
| 2 | 50 | 33.5 | 1.5 | 10 wt. % EAS 3 | 1.84 |
| | | | | 5 wt. % EAS 4 | |
| 3 | 37.5 | 51 | 1.5 | 8 wt. % OA 5 | 1.57 |
| | | | | 2 wt. % AL 61 | |
| 4 | 37.5 | 51 | 1.5 | 2 wt. % OA 5 | 1.84 |
| | | | | 8 wt. % AL 61 | |
| 5 | 37.5 | 46 | 1.5 | 10 wt. % OA 5 | 1.35 |
| | | | | 5 wt. % AL 61 | |
| 6 | 37.5 | 46 | 1.5 | 5 wt. % OA 5 | 1.26 |
| | | | | 10 wt. % AL 61 | |

OA 5 is oxidized polyethylene wax available as Luwax OA5 from BASF.
EAS 3 is polyethylene wax available as Luwax EAS 3 from BASF.
EAS 4 is polyethylene wax available as Luwax EAS 4 from BASF.
AL 61 is polyethylene wax available as Luwax AL 61 from BASF.

### EXAMPLE 3

Penetrometer Tests

The surface hardness of various compositions was tested using a penetrometer carrying a weight of 150 grams which was released for a time period of 5 seconds. The penetration of the needle was recorded in units of (0.1 mm). First, the compositions were placed in a hot room at 140° F. for approximately 24 hours prior to penetrometer tests. Subsequently, the blocks were placed in a heat chamber until a surface temperature of 220° F. was reached and an internal temperature of about 170° F. was reached. When using the medium sized probe (3 mm diameter ball), a first composition (44 wt. % amido quat, 54.5 wt. % Acrawax C, and 1.5 wt. % fragrance) had an internal temperature of 170° F. and a penetration value of 14-15 mm. Sample 1 from Table 2 gives a value of 18-26 mm with at an internal temperature of 155° F.

The lower the penetration value measured by the penetrometer, the harder the block is. Hard surfaces reduce the chance of shearing the product off of the carrier.

### EXAMPLE 4

Melt Point

The melting point was determined by scraping a small amount of product from a composition and placing it between two glass slides which were placed on a Fischer Melting Point Apparatus. The melting points listed in Table 3 are the point at which either the product “wetted out” or most of the material was melted.

TABLE 3
Melting Temperature

| | amido quat | ethylene bis- | fragrance | stearic acid | adipic acid | citric acid | | melting point |
|---|---|---|---|---|---|---|---|---|
| Sample | (wt. %) | stearamide (wt. %) | (wt. %) | ethoxylate (wt. %) | (wt. %) | (wt. %) | wax (wt. %) | (° C.) |
| 1 | 30 | 65 | | 5 | | | | 133-143 |
| 2 | 40 | 55 | | 5 | | | | 133-137 |
| 3 | 30 | 68 | | 2 | | | | 141-144 |
| 4 | 40 | 58 | | 2 | | | | 131-144 |
| 5 | 30 | 65 | | | | 5 | | 132-142 |
| 6 | 30 | 55 | | | | | 15 wt. % Unithox | 137-139 |
| | | | | | | | 480 | |
| 7 | 30 | 65 | | | 2.5 | 2.5 | | 135-138 |
| 8 | 30 | 60 | | 5 | | 5 | | 136-138 |
| 9 | 37.5 | 0 | 1.5 | | | | 61 wt. % Licowax | 142 |
| | | | | | | | C micropowder | |
| 10 | 37.5 | 0 | 1.5 | | | | 61 wt. % ceridust | 149-159 |
| | | | | | | | 3910 | |
| 11 | 37.5 | 41 | 1.5 | | | | 20 wt. % EAS 4 | 135-140 |
| 12 | 50 | 28.5 | 1.5 | | | | 15 wt. % OA 5 | 135-145 |
| | | | | | | | 5 wt. % EAS 5 | |

Unithox 480 is available from Baker Hughes.
Licowax C micropowder is an ethylene bis-stearamide available from Clariant.
Ceridust 3910 is an amide wax available from Clariant.
EAS 4 is a polyethylene wax available as Luwax EAS 4 from BASF.
OA 5 is oxidized polyethylene wax available as Luwax OA 5 from BASF.

### EXAMPLE 7

Several compositions where prepared and tested according to the precedures reported in the previous examples. Each of these compositions and the measured properties are reported below.

Composition A

| | | |
|---|---|---|
| Acrawax C | 33.5 | wt. % |
| Quat | 50 | wt. % |
| Fragrance | 1.5 | wt. % |
| Luwax OA 5 | 5 | wt. % |
| Luwax AL 61 | 10 | wt. % |
| Shrinkage | 1.26% | |
| MP | 130-135° | C. |
| Max Load | 1.59 | lbs |
| Flexibility | .212 | inch |

Composition B

| | | |
|---|---|---|
| Acrawax C | 33.5 | wt. % |
| Quat | 50 | wt. % |
| Fragrance | 1.5 | wt. % |
| Luwax OA 5 | 15 | wt. % |
| Shrinkage | 1.845 | wt. % |
| MP | 130-135° | C. |
| Max Load | 2.37 | lbs |
| Flexibility | .199 | inch |

Composition C

| | | |
|---|---|---|
| Acrawax C | 38.5 | wt. % |
| Quat | 50 | wt. % |
| Fragrance | 1.5 | wt. % |
| Luwax EAS 3 | 5 | wt. % |
| Luwax EAS 4 | 5 | wt. % |
| Shrinkage | 5.1% | wt. |
| MP | 134-139° | C. |
| Max Load | 1.371 | lbs |
| Flexibility | .178 | inch |

Composition D

| Acrawax C | 41 | wt. % |
|---|---|---|
| Quat | 39 | wt. % |
| Fragrance | 1.5 | wt. % |
| Citric Acid | 10 | wt. % |
| Adipic Acid | 5 | wt. % |
| Steareth 100 | 5 | wt. % |
| Shrinkage | N/A | |
| MP | N/A | |
| Max Load | 2.45 | lbs |
| Flexibility | .695 | inch |

Composition E

| Acrawax C | 49.5 | wt. % |
|---|---|---|
| Quat | 44 | wt. % |
| Fragrance | 1.5 | wt. % |
| Citric Acid | 1% | wt. |
| Adipic Acid | 1% | wt. |
| Steareth 100 | 3% | wt. |
| Shrinkage | 5.3 | |
| MP | N/A | |
| Max Load | 1.63 | lbs |
| Flexibility | .337 | inch |

Quat is amido quat methyl bis (hydr. tallowamidoethyl)-2-hydroxyethyl ammonium methyl sulfate available under the name Varisoft DS110 from Degussa.
Acrawax C is ethylene bis-stearamide from Lonza, Inc.
Luwax OA 5 is oxidized polyethylene wax from BASF.
Luwax AL 61 is polyethylene wax from BASF.
Luwax EAS 3 is polyethylene wax from BASF.
Luwax EAS 4 is polyethylene wax from BASF.
Steareth 100 is a fatty alcohol ethoxylate available as Volpo-S-100 from Croda.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A fabric treatment article comprising a fabric treatment composition and a substrate in contact with the fabric treatment composition, wherein the fabric treatment composition is provided in the form of a mass having a size of at least about 25 grams, and comprises a result of melt mixing a composition comprising:
about 30 wt. % to about 70 wt. % of a fabric softener component comprising at least one quaternary ammonium compound;
about 10 wt. % to about 60 wt. % carrier component; and
about 5 wt. % to about 30 wt % elasticity, shrinkage, or surface hardness additive;
wherein the fabric treatment composition, when provided having a size of 6 inch×1 inch×⅛ inch, has a flexibility of at least about 0.2 inch and strength sufficient to withstand a maximum load of at least about 1 lb_{f} when tested on a 5544 Instron material test instrument using 4 inch posts separated by 4 inches, a shrinkage of less than 5% after placing a sample in an oven for two weeks at 107° C., and a surface hardness sufficient to reduce penetration of a 3 mm diameter ball to less than 26 mm depth in the composition when provided at a surface temperature of 220° F. and an internal temperature of about 170° F. and at a force of 150 grams for 5 seconds.

2. A fabric treatment article accordingly to claim 1, wherein the substrate comprises at least one of polyethylene, polypropylene, polycarbonate, polyamide, polyester, or mixtures thereof.

3. A fabric treatment article according to claim 1, wherein the fabric treatment agent comprises a fabric softener component comprising at least one quaternary ammonium compound.

4. A fabric treatment article according to claim 3, wherein the fabric softener component comprises at least one quaternary ammonium compound selected from at least one of alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof.

5. A fabric treatment article according to claim 3, wherein the fabric softener component comprises an alkylated quaternary ammonium compound having an alkyl group containing between about 6 and 24 carbon atoms.

6. A fabric treatment article according to claim 5, wherein the alkylated quaternary ammonium compound comprises at least one of monoalkyl trimethyl quaternary ammonium compound, monomethyl trialkyl quaternary ammonium compound, and dialkyl dimethyl quaternary ammonium compound.

7. A fabric treatment article according to claim 3, wherein the fabric softener component comprises at least one of dimethyl alkyl benzyl quaternary ammonium compound, monomethyl dialkyl benzyl quaternary ammonium compound, trimethyl benzyl quaternary ammonium compound, and trialkyl benzyl quaternary ammonium compound, wherein the alkyl group contains between about 6 and about 24 carbon atoms.

8. A fabric treatment article according to claim 3, wherein the fabric softener component comprises at least one of methyldialkoxy alkyl quaternary ammonium compound, trialkoxy alkyl quaternary ammonium compound, trialkoxy methyl quaternary ammonium compound, dimethyl alkoxy alkyl quaternary ammonium compound, and trimethyl alkoxy quaternary ammonium compound, wherein the alkyl group contains between about 6 and about 24 carbon atoms and the alkoxy group contains about 1 and about 50 repeating units, and each repeating alkoxy group contains between about 2 and about 3 carbon atoms.

9. A fabric treatment article according to claim 3, wherein the fabric softener component comprises at least one of methyl bis(tallow amidoethyl)-2-hydroxyethyl ammonium methyl sulfate, methyl bis(oleylamidoethyl)-2-hydroxyethyl ammonium methyl sulfate, methyl bis(hydrogenated tallow amidoethyl)-2-hydroxyethyl ammonium methyl sulfate and mixtures thereof.

10. A fabric treatment article according to claim 1, wherein the carrier component comprises at least one of ethylene bisamides, primary alkylamides, alkanolamides, polyamides, alcohols containing at least 12 carbon atoms, alkoxylated alcohols containing at least 12 carbon atoms, carboxylic acids containing at least about 12 carbon atoms, derivatives thereof, and mixtures thereof.

11. A fabric treatment article according to claim 1, wherein the carrier component comprises ethylene bisamide having the formula: 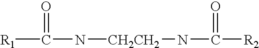
wherein R₁ and R₂ can be the same or different and each are an alkyl group containing at least 6 carbon atoms.

12. A fabric treatment article according to claim 1, wherein the carrier component comprises a primary alkylamide having the formula: 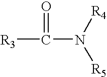
wherein R₃ is an alkyl group containing between about 6 and about 24 carbon atoms, and R₄ and R₅ can be the same or different and each are hydrogen or an alkyl group containing 1 to about 24 carbon atoms.

13. A fabric treatment article according to claim 1, wherein the carrier component comprises an alkanolamide having the formula: 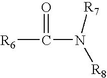
wherein R₆ is an alkyl group containing between about 6 and about 24 carbon atoms, and R₇ and R8 can be the same or different and each are one of hydrogen, C₂H₄OH, and C₃,H₆OH.

14. A fabric treatment article according to claim 1, wherein the carrier component comprises at least one of ethylene bis-stearamide, ethylene bispalmitamide, ethylenebisoleamide, ethylene bisbehenamide, and mixtures thereof.

15. A fabric treatment article according to claim 1, wherein the additive comprises at least one of wax, organic acid, surfactant, or clay.

16. A fabric treatment article according to claim 1, wherein the composition comprises about 8 wt. % to about 25 wt. % of the additive.

17. A method for treating fabric in a dryer, the method comprising:
(a) drying fabric in a dryer in the presense of a fabric treatment article attached to an inside surface of the dryer, wherein the fabric treatment article comprises a fabric treatment composition and a substrate in contact with the fabric treatment composition, wherein the fabric treatment composition is provided in the form of a mass having a size of at least about 25 grams and comprises a result of melt mixing a composition comprising:
about 30 wt. % to about 70 wt. % of a fabric softener component comprising at least one quaternary ammonium compound;
about 10 wt. % to about 60 wt. % carrier component; and
about 5 wt. % to about 30 wt % elasticity, shrinkage, or surface hardness additive;
wherein the fabric treatment composition, when provided having a size of 6 inch×1 inch×⅛ inch, has a flexibility of at least about 0.2 inch and strength sufficient to withstand a maximum load of at least about 1 lb_{f} when tested on a 5544 Instron material test instrument using 4 inch posts separated by 4 inches, a shrinkage of less than 5% after placing a sample in an oven for two weeks at 107° C., and a surface hardness sufficient to reduce penetration of a 3 mm diameter ball to less than 26 mm depth in the composition when provided at a surface temperature of 220° F. and an internal temperature of about 170° F. and at a force of 150 grams for 5 seconds.

18. A method according to claim 17, further comprising:
(a) drying the fabric in the dryer, wherein the dryer achieve a temperature of less than about 160° F.

19. A method according to claim 17, wherein the fabric treatment composition dispenses a sufficient amount of the fabric softener component for at least five cycles in a dryer to 200 cycles in a dryer.

20. A method according to claim 17, wherein the fabric treatment composition comprises a solid having a size of about 30 grams to about 400 grams.

21. A method according to claim 17, comprising attaching the fabric treatment article to a cradle, wherein the cradle is attached to the inside surface of a dryer.
